(19) United States
(12) Patent Application Publication
(10) Pub. No.: US 2016/0240983 A1
(43) Pub. Date: Aug. 18, 2016

(54) ELECTRICAL CONNECTOR

(71) Applicant: ALLTOP ELECTRONICS (SUZHOU) LTD., Taicang City (CN)

(72) Inventors: Wang-I YU, JHONGHE_City (TW); Mao-Jung HUANG, JHONGHE_City (TW)

(73) Assignee: ALLTOP ELECTRONICS (SUZHOU) LTD., Taicang City (CN)

(21) Appl. No.: 14/739,522

(22) Filed: Jun. 15, 2015

(30) Foreign Application Priority Data
Feb. 15, 2015 (CN) 201510082934.9

(51) Int. Cl. H01R 13/6585; H01R 13/66

(52) U.S. Cl. CPC H01R 13/6585; H01R 13/665

(57) ABSTRACT

An electrical connector includes an insulative housing having a front space and a rear space, a number of electrical contacts each having a spring section projecting into the front space and a soldering section, an internal circuit board disposed in the rear space, and a pair of spring tabs secured to opposite sides of the insulative housing. The internal circuit board has a number of first golden fingers to connect with the soldering sections, a number of second golden fingers. The internal circuit board has a number of grounding pad adjacent to the second golden finger. The pair of spring tabs each has a locking section extending into the front space and a connecting section contacting with the grounding pad of the internal circuit board.

### BACKGROUND OF THE INVENTION

1. Field of the Invention

The present invention relates to an electrical connector, and more particularly to an electrical connector is easy to fabricate.

2. Description of Related Art

In the end of 2008, USB Implementers Forum (USB-IF) released USB 3.0 specification. The USB 3.0 electrical connector adds two pair of differential contacts and a grounding contact to the USB 2.0 for increasing the speed rate up to 5 GB/s and is backward compatible with USB 2.0. With the development of electronic industry, USB 3.0 can't meet the requirements of consumer. Thus, USB-IF announced USB Type-C connectors which is reversible so that it can be used in any orientation. Moreover, it gets faster and EMI of which is improved. However, USB C-type connector is complicated and challenges the manufacturing and the assembling ability.

Hence, it is desired to provide an electrical connector to overcome the problems mentioned above.

### BRIEF SUMMARY OF THE INVENTION

Accordingly, an object of the present invention is to provide an electrical connector which facilitates to manufacture and has improved transmitting speed.

The present invention is directed to an electrical connector includes an insulative housing having a front space and a rear space communicated with each other, a plurality of electrical contacts each having a spring section projecting into the front space and a soldering section connected with the spring section, an internal circuit board disposed in the rear space of the insulative housing, and a pair of spring tabs secured to opposite sides of the insulative housing. The internal circuit board has a plurality of first golden fingers at a front end thereof to connect with the soldering sections, a plurality of second golden fingers at a rear end thereof, and a plurality of conductive traces connected with the first and second golden fingers. The internal circuit board has a plurality of grounding pads adjacent to the second golden finger. The pair of spring tabs each has a locking section extending into the front space and a connecting section contacting with the grounding pad of the internal circuit board.

The present invention is directed to an electrical connector includes an insulative housing having a front space and a rear space communicated with each other; a plurality of electrical contacts arranged in two rows and each having a spring section projecting into the front space and a soldering section connected with the spring section, an internal circuit board disposed in the rear space of the insulative housing, and a metal shell surrounding the insulative housing. The internal circuit board has a plurality of first golden fingers at a front end thereof to connect with the soldering sections, a plurality of second golden fingers at a rear end thereof, and a plurality of conductive traces connected with the first and second golden fingers. The first golden fingers, the second golden fingers and the conductive traces form a plurality of electrical circuits corresponding to the electrical contacts respectively.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the present invention;

FIG. 2 is another perspective view of the electrical connector shown in FIG. 1;

FIG. 3 is a partial exploded view of the electrical connector shown in FIG. 1

FIG. 4 is an exploded view of the electrical connector shown in FIG. 1;

FIG. 5 is an exploded view of the internal circuit board shown in FIG. 3;

FIG. 6 is similar to FIG. 4 but viewed from a different aspect; and

FIG. 7 is a cross-sectional view of the electrical connector shown in FIG. 1.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

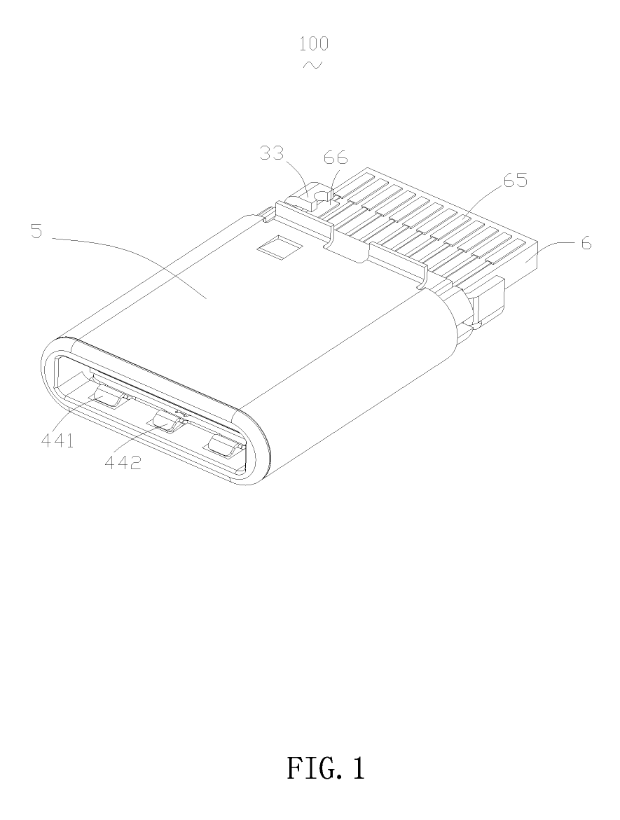

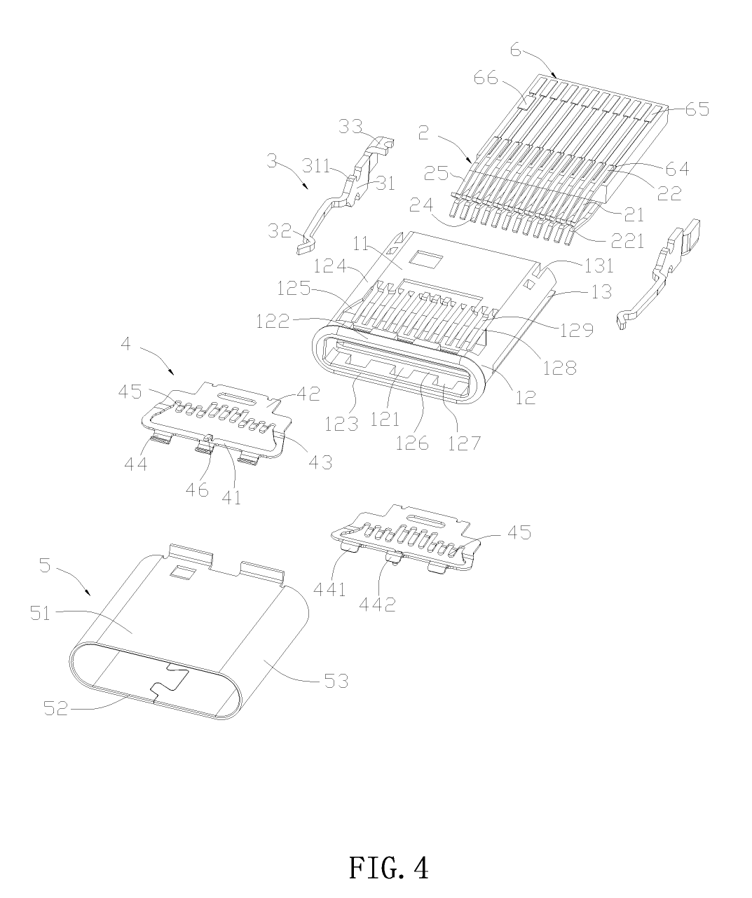

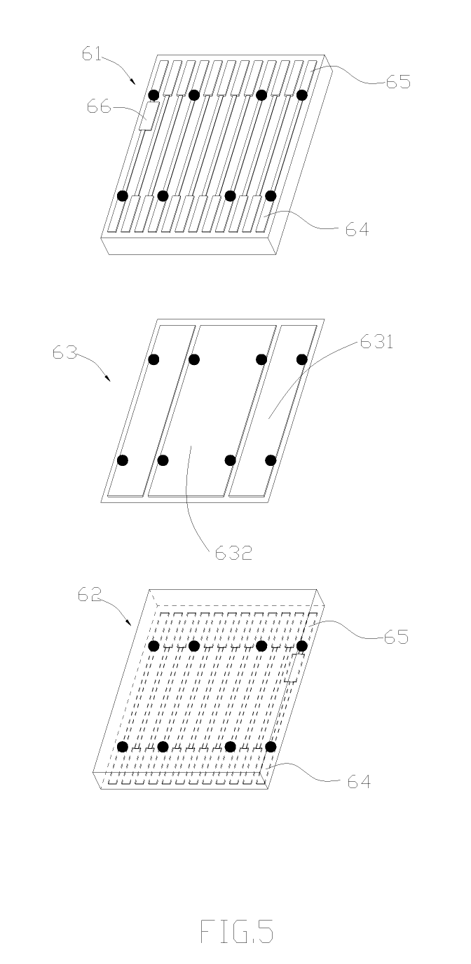

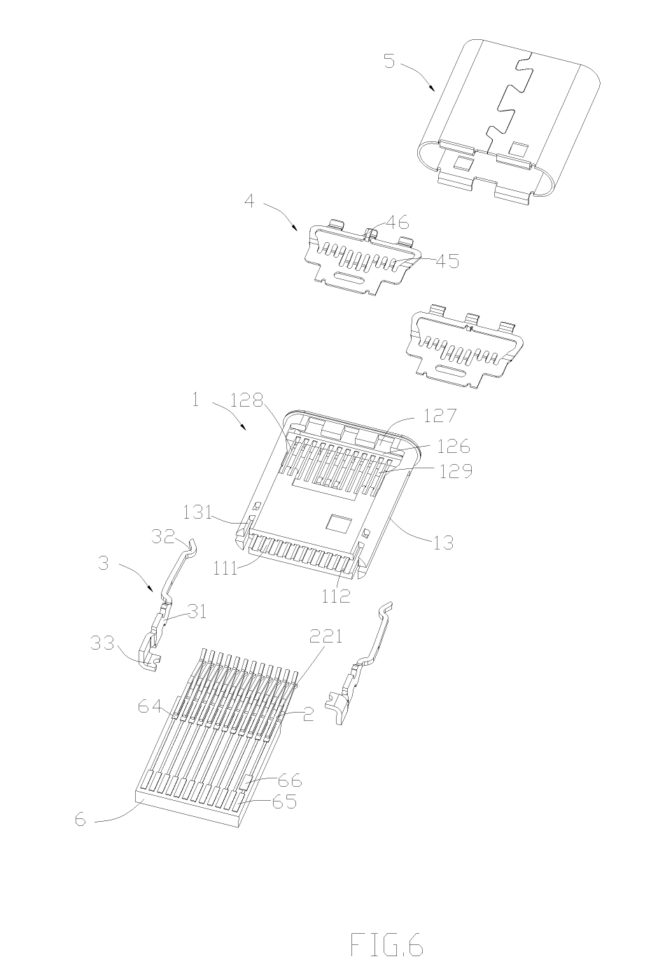

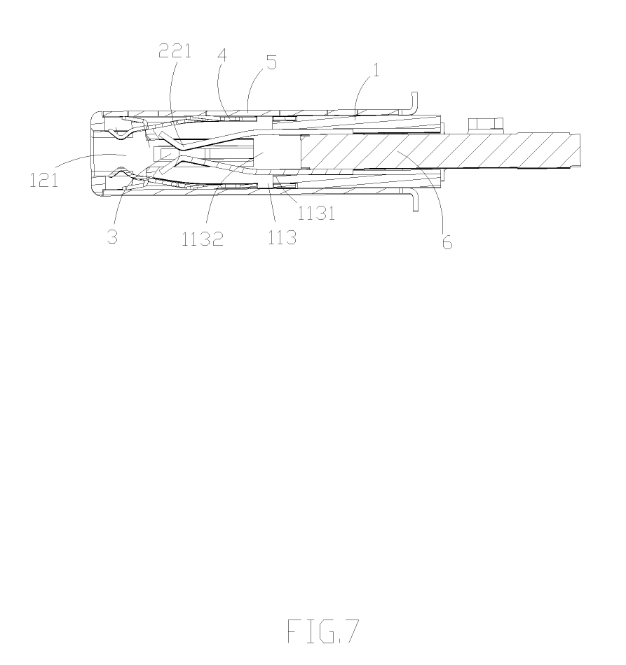

Please referring to FIG. 1 to FIG. 7, the present invention is directed to an electrical connector 100 including an insulative housing 1, a plurality of electrical contacts 2 secured to the insulative housing 1, a pair of spring tabs 3, two grounding pieces 4 disposed on the top and bottom sides of the insulative housing 1, an internal circuit board 6, and a metal shell 5 surrounding the insulative housing 1.

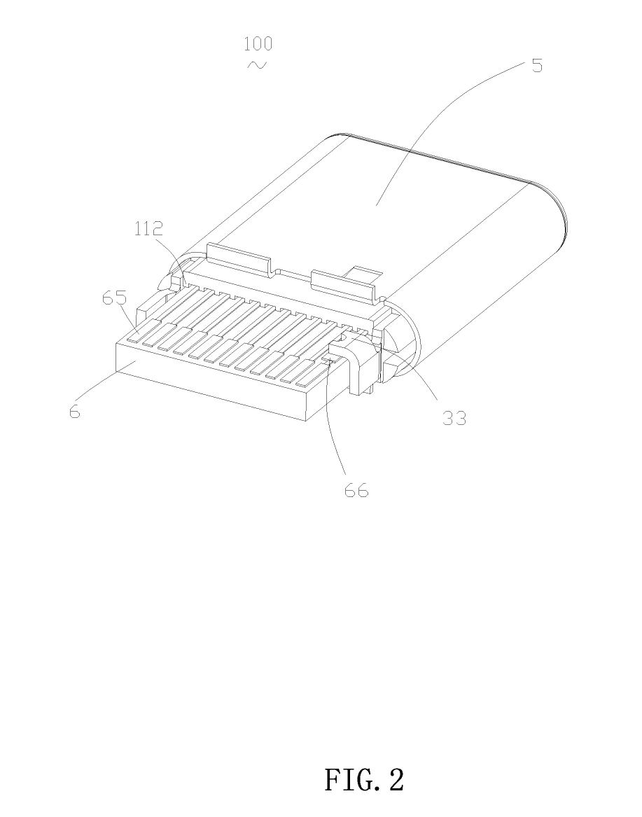

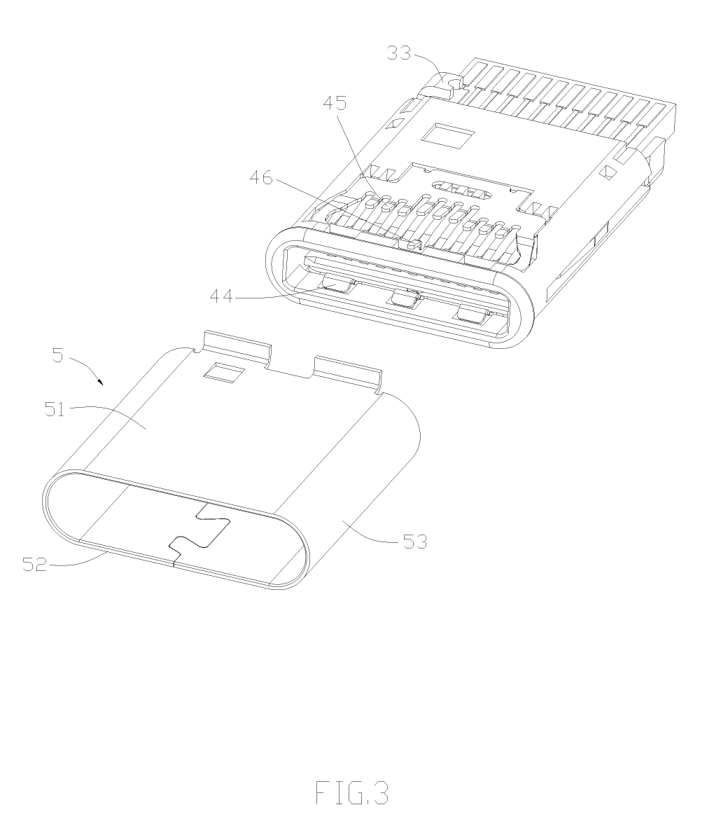

Please referring to FIG. 2 and FIG. 3, the insulative housing 1 has a main portion 11 and a mating portion 12 projecting forwardly from the main portion 11. The main portion 11 defines a rear space 111 opening to a rear face thereof for receiving the internal circuit board 6. The rear space 111 is provided with a plurality of protrusions 112 for sandwiching and retaining the internal circuit board 6.

The insulative housing 1 is configured to an oval—shape and has a top wall 122, a bottom wall 123, and a pair of curved sidewalls 124 thereby define a front space 121 opening to a front face of the mating portion 12. A partition 113 is located between the front space 121 and the rear space 111 and includes a plurality of passageways 1131 and a plurality of separating strips 1132 located between the passageways 1131. The passageways 1131 are arranged in two rows along an up to down direction.

Each electrical contact 2 has a spring section 21 and a soldering section 22 connecting with each other. The soldering section 22 is disposed in the rear space 111 and contacts with the internal circuit board 6. The spring section 21 extends through the passageway 1131 and projects into the front space 121. The spring sections 21 are arranged in upper and lower sides of the front space 121 and are provided with a plurality of V-shaped contacting sections 221 for clamping a tongue of a mating connector (not shown).

The insulative housing 1 defines a pair of longitudinal grooves 13 at opposite sides thereof. The pair of grooves 13 are communicated with the front space 121 and the rear space 111 at front end and rear end of the insulative housing 1. A plurality of slots 131 are defined on the top and bottom walls 122, 123 and communicated with the rear space 111.

The mating portion 12 defines a pair of recesses 125 recessed from top and bottom surfaces of the insulative housing 1, a pair of passageways 26 extending through the top and bottom walls 122, 123 and communicated with the recesses 125 and the front space 121, a plurality of channels 128, and a plurality of partitions 129 separating the channels 128. The passageway 126 includes a plurality of notches 127 disposed on the internal sides of the top wall 122 and the bottom wall 123. The channels 128 extend through the top wall 122 and the bottom wall 123 and communicate with the recesses 125. The channels 128 are corresponding to electrical contacts 2 for providing a deforming space for the spring sections 21 when the electrical connector 100 engages with the mating connector.

The electrical contacts 2 are arranged in two rows and include a plurality of signal contacts 24 and a plurality of grounding contacts 25. In each row of the electrical contacts 2, the grounding contacts 25 are located at outermost sides and the signal contacts 4 are located between the grounding contacts 25. The signal contacts 24 includes two pair of high frequency signal contacts adjacent to the grounding contacts 25 respectively, two power contacts at inner side of the high frequency signal contacts and four low frequency signal contacts located between the two power contacts 24. The electrical contacts 2 on the top row and the bottom row are similar but disposed in opposite directions.

The present invention is provided with an internal circuit board 6 which facilitates to manufacture. Please referring to FIG. 3 to FIG. 6, the internal circuit board 6 has a top layer 61, a bottom layer 62, and a grounding layer 63. The top layer 61 and the bottom layer 62 each include a plurality of first golden fingers 64 at a front end thereof for electrically connecting with the electrical contacts 2, a plurality of second golden fingers 24 at a rear end thereof for electrical connecting with external wires (not shown), and a plurality of conductive traces (not labeled) connected with the first and second golden fingers 21, 24.

The grounding layer 63 has two grounding copper foils 631 at opposite sides thereof and a middle copper foil 632 located between the grounding copper foils 631. The grounding copper foils 631 are sandwiched by the high frequency signal contacts and the grounding contacts 25 of the top row and the bottom row thereby preventing crosstalk between the two rows. The middle copper foils 632 are sandwiched by the power contacts of the top row and the bottom row. Furthermore, the conductive traces corresponding to the grounding contacts 25 on the top layer 61 and the bottom layer 62 are connected with the grounding copper foils 631 via a plurality of plated-through holes (not labeled) so as to establish a grounding path between the grounding contacts 25 of the top and bottom rows and the grounding copper foil 631 for improve shielding.

The conductive traces corresponding to the power contacts on the top layer 61 and the bottom layer 62 are connected with middle copper foils 632 via a plurality of plated-through holes (not labeled) so as to establish a power path between the power contacts of the top and bottom rows and the middle copper foil 632 thereby form two parallel power paths between the top and bottom layers 201, 202 and the middle copper foil 632 and decrease the resistance for transmitting biggish current.

The top layer 61 and the bottom layer 62 each is provided with a grounding pad 66 on the conductive traces electrically connected with the grounding contacts 25 and adjacent to the second golden finger 65. The internal circuit board 6 is inserted into the rear space 111 with the second golden fingers 65 and the grounding pads 66 exposed to an exterior of the insulative housing 1 for facilitating soldering.

Please referring to FIG. 1 to FIG. 6, the pair of spring tabs 3 are received in the longitudinal groove 13 of the insulative housing 1 and each has a retention section 31 attached to the slot 131, a locking section 32 extending into the front space 121 and a connecting section 33 bending from the retention section 31. The retention section 31 is provided with a plurality of barbs 311 engaging with slot 131. The locking section 32 is locked with the mating connector (not shown). The connecting section 33 is soldered to the grounding pad 66 to establish a grounding path between the mating connector and the electrical connector 100.

Please refer to FIG. 1 to FIG. 7, the grounding pieces 4 are received in the recesses 5 respectively and separated from the electrical contacts 2 thereby provide shielding for the electrical contacts 2. The grounding pieces 4 are located at opposite sides of the front space 121 and each includes a front beam 41, a rear beam 42 and two side beams 43 connecting the front beam 41 with the rear beam 42, a plurality of front tabs 44 bending from the front beam 41 and projecting into the front space 44, and a plurality of internal fingers 45 bending from the rear beam 42 and projecting out of the insulative housing 1. The internal fingers 45 are aligned with the partitions 129 and staggered with the channels 128 so that each of the internal fingers 45 is corresponding two adjacent electrical contacts 2 and provides shielding therebetween. The front beam 41 is received in the passageway 126 and the front tabs 44 extend through the notches 127 and project into the front space 121.

The front tabs 44 include two side tabs 441 and a central tab 442. The grounding piece 4 further has a front finger 46 opposite to the central tab 442 for contacting with the shell 5.

The shell 5 is configured to an oval—shape and surrounding the insulative housing 1. The shell 5 has a top wall 51, a bottom wall 52, and two curved side walls 53 extending between the top wall 51 and the bottom wall 53. The internal fingers 45 and the front fingers 46 contact with the top wall 51 and the bottom wall 52 of the shell 5 after assembling.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a front space and a rear space communicated with each other;
a plurality of electrical contacts each having a spring section projecting into the front space and a soldering section connected with the spring section;
an internal circuit board disposed in the rear space of the insulative housing and having a plurality of first golden fingers at a front end thereof and connecting with the soldering sections, a plurality of second golden fingers at a rear end thereof, and a plurality of conductive traces connected with the first and second golden fingers, the internal circuit board having a plurality of grounding pads adjacent to the second golden finger;
a pair of spring tabs secured to opposite sides of the insulative housing and each having a locking section extending into the front space and a connecting section contacting with the grounding pad of the internal circuit board.

2. The electrical connector as claimed in claim 1, wherein the rear space is provided with a plurality of protrusions to sandwich and retain the internal circuit board.

3. The electrical connector as claimed in claim 1, wherein the internal circuit board extends out of the rear space with the second golden fingers and the grounding pad exposed to an exterior of the insulative housing.

4. The electrical connector as claimed in claim 1, wherein the insulative housing defines a pair of longitudinal grooves at opposite sides thereof and communicated with the front space and the rear space for receiving the pair of spring tabs.

5. The electrical connector as claimed in claim 1, wherein the electrical contacts are arranged in two rows and located at opposite sides of the internal circuit board, and wherein the spring sections are located at opposite sides of the front space.

6. The electrical connector as claimed in claim 1, wherein the internal circuit board has a top layer, a bottom layer, and a grounding layer, and wherein the first and second golden fingers are disposed on the top layer and the bottom layer.

7. The electrical connector as claimed in claim 6, wherein each row of the electrical contacts includes two grounding contacts located at outermost sides and a plurality of signal contacts located therebetween, and wherein the signal contacts includes two pair of high frequency signal contacts adjacent to the grounding contacts respectively, two power contacts at inner side of the high frequency signal contacts and four low frequency signal contacts located between the two power contacts, and wherein the electrical contacts on the top row and the bottom row are similar but disposed in opposite directions, and wherein the first and second golden fingers of the internal circuit board are corresponding to the electrical contacts.

8. The electrical connector as claimed in claim 7, wherein the grounding layer has two grounding copper foils at opposite sides thereof and sandwiched by the high frequency signal contacts and the grounding contacts of the top row and the bottom row, and wherein the conductive traces corresponding to the grounding contacts on the top layer and the bottom layer connect with the grounding copper foils via a plurality of plated-through holes.

9. The electrical connector as claimed in claim 8, wherein the grounding layer has a middle copper foil located between the grounding copper foils and sandwiched by the power contacts of the top row and the bottom row, and wherein the conductive traces on the top layer and the bottom layer corresponding to the power contacts connect with middle copper foils via a plurality of plated-through holes.

10. The electrical connector as claimed in claim 9, wherein a partition is located between the front space and the rear space and includes a plurality of passageways and a plurality of separating strips located between the passageways, and wherein the spring sections of the electrical contacts extend through the passageways and projecting into the front space.

11. The electrical connector as claimed in claim 1, wherein the electrical connector further comprises a pair of grounding piece located at opposite sides of the front space and a metal shell surrounding the insulative housing, and wherein the grounding piece is provided with a plurality of fingers contacting with the metal shell.

12. An electrical connector comprising:
an insulative housing having a front space and a rear space communicated with each other;
a plurality of electrical contacts each having a spring section projecting into the front space and a soldering section connected with the spring section, the electrical contacts being arranged in two rows;
an internal circuit board disposed in the rear space of the insulative housing and having a plurality of first golden fingers at a front end thereof to connect with the soldering sections, a plurality of second golden fingers at a rear end thereof, and a plurality of conductive traces connected with the first and second golden fingers, the first golden fingers, the second golden fingers and the conductive traces forming a plurality of electrical circuits corresponding to the electrical contacts respectively; and
a metal shell surrounding the insulative housing.

13. The electrical connector as claimed in claim 12, wherein the insulative housing has a top wall, a bottom wall, and a pair of curved sidewalls connected with the top wall and the bottom wall, and wherein the metal shell is configured to similar shape with the insulative housing.

14. The electrical connector as claimed in claim 12, further comprising two spring tabs secured to opposite sides of the insulative housing and each having a locking section extending into the front space and a connecting section contacting with two grounding pads of the internal circuit board.

15. The electrical connector as claimed in claim 14, wherein the grounding pads are located adjacent to the second golden fingers, and wherein the grounding pads and the second golden fingers are projecting out of the insulative housing.

16. The electrical connector as claimed in claim 12, further comprising a pair of grounding pieces located at opposite sides of the front space, and wherein each of the grounding piece is provided with a plurality of fingers contacting with the metal shell, and wherein part of the fingers are located adjacent to the electrical contacts, and each of the part of the fingers is corresponding two adjacent electrical contacts and disposed between said two adjacent electrical contacts.

17. The electrical connector as claimed in claim 16, wherein the grounding piece has a plurality of front tabs projecting into the front space.

18. The electrical connector as claimed in claim 12, wherein each row of the electrical contacts includes two grounding contacts located at outermost sides and a plurality of signal contacts located therebetween, and wherein the signal contacts includes two pair of high frequency signal contacts adjacent to the grounding contacts respectively, two power contacts at inner side of the high frequency signal contacts and four low frequency signal contacts located between the two power contacts, and wherein the electrical contacts on the top row and the bottom row are similar but disposed in opposite directions.

19. The electrical connector as claimed in claim 12, wherein the internal circuit board has a top layer, a bottom layer, and a grounding layer, and wherein the first and second golden fingers, and the conductive traces are disposed on the top layer and the bottom layer.

20. The electrical connector as claimed in claim 19, wherein the grounding layer has two grounding copper foils at opposite sides thereof and a middle copper foil located between the grounding copper foils, and wherein the grounding copper foils and the middle copper foils are electrically connected with the corresponding electrical circuits and electrical contacts via a plurality of plated-through holes.
